(19) United States
(12) Patent Application Publication
(10) Pub. No.: US 2016/0348428 A1
(43) Pub. Date: Dec. 1, 2016

(54) Zebra Shade

(71) Applicant: Li-Ming Cheng, Kaohsiung (TW)

(72) Inventor: Li-Ming Cheng, Kaohsiung (TW)

(21) Appl. No.: 14/726,669

(22) Filed: Jun. 1, 2015

(51) Int. Cl. E06B 9/40

(52) U.S. Cl. CPC E06B 9/40; E06B 2009/405; E06B 2009/2405

(57) ABSTRACT

A zebra shade includes a spool unit rotatably mounted to a supporting member. The spool unit includes first and second spools. A weight unit includes a weight rod and a positioning member movably mounted on the weight rod. A first shade includes first densely textured portions and first hollow portions alternating with the densely textured portions. The first shade further includes first and second engagement portions on two opposite ends thereof. The first engagement portion is mounted to the first spool. The second engagement portion is mounted to the weight rod. A second shade includes second densely textured portions and second hollow portions alternating with the second densely textured portions. The second shade further includes third and fourth engagement portions on two opposite ends thereof. The third engagement portion is mounted to the second spool. The fourth engagement portion is mounted to the positioning member.

### BACKGROUND OF THE INVENTION

1. Field of the Invention

The present invention relates to a window shade and, more particularly, to a zebra shade permitting adjustment of the light input at a fixed, predetermined height.

2. Description of the Related Art

The light input through an ordinary window shade is controlled by opening and closing the window shade. Unlike the ordinary window shade that can only adjust the light input by adjusting the area of the shade covering the window, a light input-adjustable window shade permits a user to more precisely adjust the light input passing therethrough into the indoor space according to the sunlight intensity and the indoor activity the user intends to do. Light input-adjustable window shades include zebra shades, accordion shades, and vision shades. A zebra shade includes densely textured portions and hollow portions alternating with the densely textured portions and can be folded into two layers overlapping with each other. The customers like zebra shades that can achieve adjustment of the light input entering the indoor space by a simple structure.

FIG. 1 shows a front view of a conventional zebra shade 9. The conventional zebra shade 9 includes a supporting member 91, a spool 92, a shade 93, and a weight rod 94. The spool 92 is rotatably mounted to the supporting member 91. An end of the shade 93 is fixed to the spool 92, such that the shade 93 can be wound around the spool 92. The other end of the shade 93 extends around the weight rod 94 and engages with the supporting member 91. The shade 93 includes a plurality of densely textured portions 931 and a plurality of hollow portions 932 alternating with the densely textured portions 931. The conventional zebra shade 9 further includes a pull cord 95 connected to the spool 92 for rotating the spool 92, such that the shade 93 can be folded or unfolded by pulling the pull cord 95.

The shade 93 is wound around the weight rod 94 to form a front shade portion 93a and a rear shade portion 93bbehind the front shade portion 93a. In a case that the user applies a force on the pull cord 95 to fold or unfold the shade 93, when the height of the weight rod 94 changes, in addition to a change in the area of the window covered by the shade 93, the relative position between the front shade portion 93a and the rear shade portion 93b is also changed to provide different brightness. As an example, during folding or unfolding of the zebra shade 9, the hollow portions 932 of the front shade portion 93a can be aligned with the hollow portions 932 of the rear shade portion 93b to permit a large amount of light to enter the indoor space after passing through the shade 93, or the densely textured portions 931 in the front shade portion 93a are aligned with the hollow portions 932 in the rear shade portion 93b to permit a small amount of light to enter the indoor space.

Since the conventional zebra shade 9 adjusts the area of the window covered by the shade 93 by changing the height of the weight rod 94 while changing the relative position between the front shade portion 93a and the rear shade portion 93b, when the user moves the weight rod 94 to a predetermined height to use the conventional zebra shade 9 to cover a portion of the area of the window, the densely textured portions 931 and the hollow portions 932 of the front shade portion 93a and the rear shade portion 93b may not be in a predetermined relative position and, thus, cannot obtain the desired brightness, such that the user has to slightly adjust the height of the weight rod 94 to permit the shade 93 to shield a certain amount of light, which not only causes inconvenience to the user but fails to permit precise adjustment of the light input, incurring many limitations to use.

Thus, a need exists for a zebra shade to solve the problem of incapability in precise control of the light input of the shade 93 at the predetermined height.

### SUMMARY OF THE INVENTION

An objective of the present invention is to provide a zebra shade permitting precise adjustment of the light input of the shade maintained in a predetermined height.

A zebra shade according to the present invention includes a supporting member and a spool unit rotatably mounted to the supporting member. The spool unit includes a first spool and a second spool. A weight unit includes a weight rod and a positioning member movably mounted on the weight rod. A first shade includes a plurality of first densely textured portions and a plurality of first hollow portions alternating with the plurality of densely textured portions. The first shade further includes first and second engagement portions on two opposite ends thereof. The first engagement portion of the first shade is mounted to the first spool. The second engagement portion of the first shade is mounted to the weight rod. A second shade includes a plurality of second densely textured portions and a plurality of second hollow portions alternating with the plurality of second densely textured portions. The second shade further includes third and fourth engagement portions on two opposite ends thereof. The third engagement portion of the second shade is mounted to the second spool. The fourth engagement portion of the second shade is mounted to the positioning member.

The plurality of first densely textured portions, the plurality of first hollow portions, the plurality of second densely textured portions, and the plurality of second hollow portions can have an identical width.

The plurality of first densely textured portions can be aligned with the plurality of second hollow portions, and the plurality of first hollow portions can be aligned with the plurality of second densely textured portions.

Alternatively, the plurality of first densely textured portions can be aligned with the plurality of second densely textured portions, and the plurality of first hollow portions can be aligned with the plurality of second hollow portions.

The weight rod can include a compartment and an opening in communication with the compartment. The fourth engagement portion of the second shade is received in the compartment. The positioning member extends through the opening to engage with the fourth engagement portion.

The positioning member can include a knob and a pressing member engaged with the knob. The knob is located outside of the compartment. The pressing member is received in the compartment. The pressing member includes a pressing portion. The pressing portion of the positioning member presses against and engages with the fourth engagement portion of the second shade.

The pressing member can include the pressing portion and an axle portion respectively on two opposite sides of the pressing member. The axle portion of the pressing member engages with the knob. The pressing portion presses against and engages with the fourth engagement portion.

The pressing member can further include an arcuate portion between the axle portion and the pressing portion.

In another example, the positioning member includes a knob and a pressing member engaged with the knob. The knob is located outside of the compartment. The pressing member is received in the compartment. The pressing member includes the pressing portion and an axle portion respectively on two opposite sides of the pressing member. The fourth engagement portion includes a slot. The slot can extend through two opposite faces of the fourth engagement portion. The pressing portion is movably received in the slot.

The positioning member can further include a limiting unit between the knob and the pressing member.

The limiting unit can include a spring, a decorative plate, and a connection seat. The decorative plate includes a front face and a rear face. The decorative plate further includes a through-hole extending from the front face through the rear face. The connection seat extends through the through-hole. The spring is mounted around the connection seat. The connection seat includes two opposite ends respectively engaged with the knob and the axle portion of the pressing member, such that two opposite ends of the spring respectively abut the knob and the front face of the decorative plate.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a front view of a conventional zebra shade.

FIG. 2 is an exploded, perspective view of a zebra shade of a first embodiment according to the present invention.

FIG. 3 is cross sectional view of the zebra shade of the first embodiment according to the present invention.

FIG. 4 is a front view of the zebra shade of the first embodiment according to the present invention at a predetermined height.

FIG. 5 is a partial, cross sectional view of the zebra shade of the first embodiment according to the present invention at the predetermined height.

FIG. 6 is a view similar to FIG. 5, with a positioning member moved.

FIG. 7 is a front view of the zebra shade of the first embodiment according to the present invention after the positioning member has been moved to a position shown in FIG. 6.

FIG. 8 is an exploded, perspective view of a zebra shade of a second embodiment according to the present invention.

FIG. 9 is an exploded, perspective view of a positioning member of the zebra shade of the second embodiment according to the present invention.

FIG. 10 is a front view of the zebra shade of the second embodiment according to the present invention at a predetermined height.

FIG. 11 is a partial, cross sectional view of the zebra shade of the second embodiment according to the present invention at the predetermined height.

FIG. 12 is a view similar to FIG. 11, with a positioning member moved.

FIG. 13 is a front view of the zebra shade of the second embodiment according to the present invention after the positioning member has been moved to a position shown in FIG. 12.

FIG. 14 is a partial, exploded, perspective view of a zebra shade of a third embodiment according to the present invention.

FIG. 15 is a partial, cross sectional view of the zebra shade of the third embodiment according to the present invention.

FIG. 16 is a view similar to FIG. 15, with a positioning member moved.

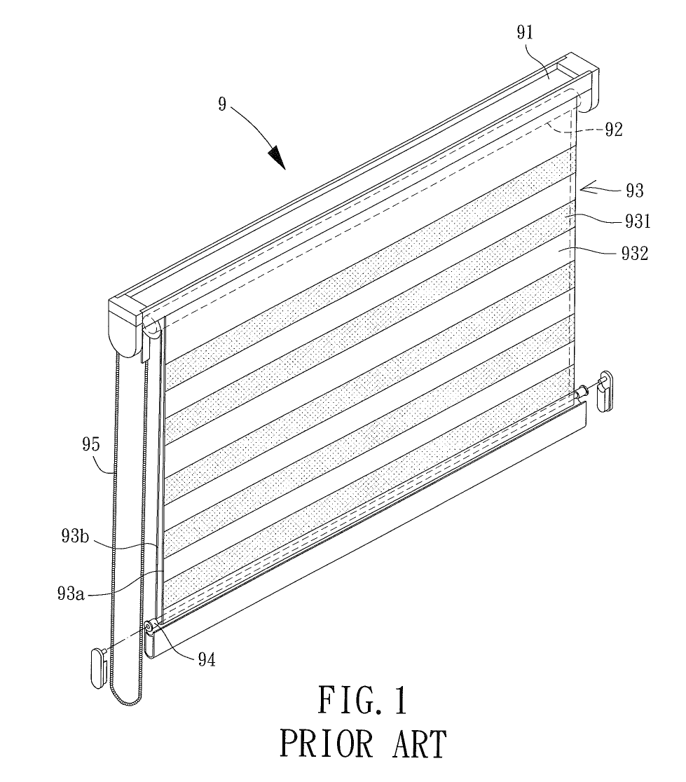

### DETAILED DESCRIPTION OF THE INVENTION

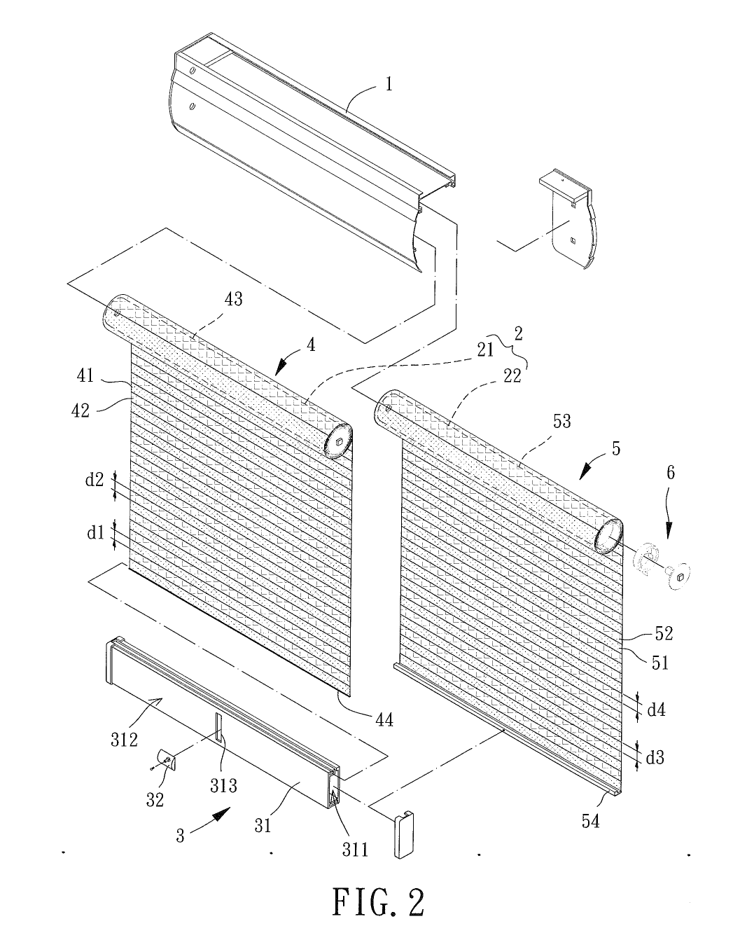

FIG. 2 is an exploded, perspective view of a zebra shade of a first embodiment according to the present invention. The zebra shade includes a shade 1, a spool unit 2, a weight unit 3, a first shade 4, and a second shade 5. The spool unit 2 is rotatably mounted to two opposite ends of the supporting member 1. Each of the first shade 4 and the second shade 5 has an end fixed to the spool unit 2. The other end of each of the first shade 4 and the second shade 5 is mounted to the weight unit 3, such that each of the first shade 4 and the second shade 5 can be unfolded or folded by changing the spacing between the supporting member 1 and the weight unit 3.

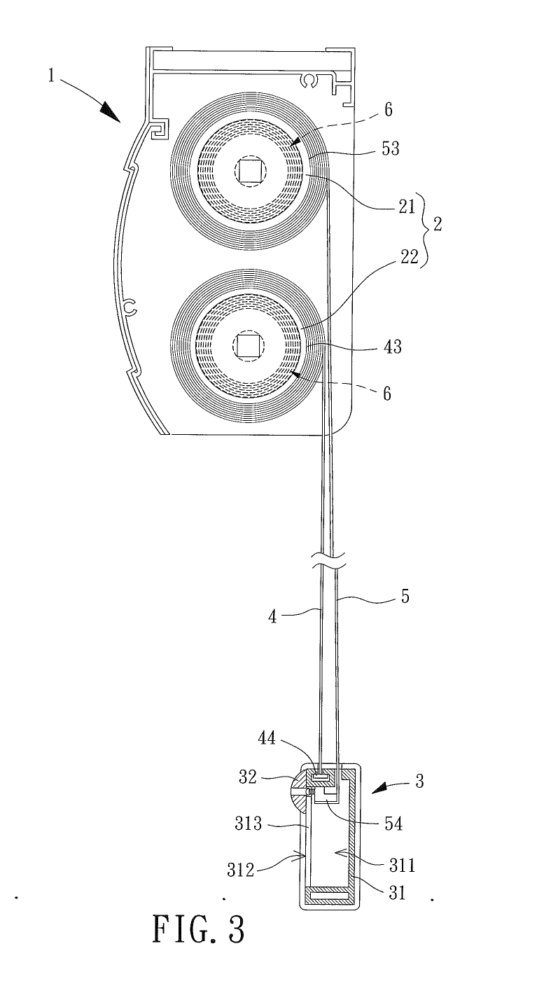

The zebra shade further includes a transmission and coiling unit 6 for positioning the zebra shade at a predetermined height. A desired area of the window can be covered by the zebra shade through operation of the transmission and cooling unit 6. In this embodiment, the transmission and cooling unit 6 is mounted to the spool unit 2 for driving the spool unit 2 to rotate, such that the first shade 4 and the second shade 5 can be folded or unfolded to position the zebra shade at the predetermined height. The first transmission and coiling unit 6 can be of a type shown in FIG. 3 of U.S. Patent Application Publication No. 2011/0036516. However, the present invention is not limited to this.

Specifically, the supporting member 1 is used to couple with the spool unit 2, such that the zebra shade according to the present invention can be fixed to a desired location on a wall or a ceiling. In this embodiment, the supporting member 1 is a housing in which the spool unit 2 is received. An end of the spool unit 2 can be fixed to an inner periphery of the spool unit 2.

The spool unit 2 includes a first spool 21 and a second spool 22 for respectively coiling the first shade 4 and the second shade 5. The first spool 21 and the second spool 22 can be mounted to the supporting member 1 and can be spaced from each other in a vertical direction (FIG. 3). The first spool 21 and the second spool 22 can be parallel to each other. However, other spatial relationships between the first spool 21 and the second spool 22 can be arranged. The first spool 21 and the second spool 22 of the zebra shade according to the present invention are preferably spaced from each other in the vertical direction, as shown in FIG. 3, to decrease the radial width of the zebra shade and to permit the first and second shades 4 and 5 mounted to the spool unit 2 to be close to each other, thereby reducing the horizontal spacing between the first shade 4 and the second shade 5 to increase the light shielding effect of the first shade 4 and the second shade 5 of the zebra shade.

The weight unit 3 is mounted to the first shade 4 and the second shade 5, such that the first shade 4 and the second shade 5 can be neatly unfolded under the gravitational force acting on the first shade 4 and the second shade 5. The weight unit 3 includes a weight rod 31 and a positioning member 32. The positioning member 32 is movably mounted on the weight rod 31. The term “movably mounted on” used herein means that the positioning member 32 can move or rotate relative to the weight rod 31. As shown in FIGS. 2 and 3, the weight rod 31 is connected to the first shade 4, and the positioning member 32 is connected to the second shade 5. In this embodiment, the weight rod 31 includes a compartment 311, an engagement face 312, and an opening 313. The opening 313 is located in the engagement face 312 and is in communication with the compartment 311. The positioning member 32 is disposed on the engagement face 312.

With reference to FIG. 2, the first shade 4 includes a plurality of first densely textured portions 41 and a plurality of first hollow portions 42. Each first densely textured portion 41 has a low transmittance.

Each first hollow portion 42 has a high transmittance. Each first densely textured portion 41 has a first width d1. Each first hollow portion 42 has a second width d2. Furthermore, the first hollow portions 42 alternate with the densely textured portions 41 to form the first shade 4 having a zebra stripe-like pattern. The direction of the first width d1 and the second width d2 is the same as the direction from the first spool 21 towards the weight unit 3. The first shade 4 further includes first and second engagement portions 43 and 44 on two opposite ends thereof. The first engagement portion 43 of the first shade 4 is mounted to the first spool 21, such that the first shade 4 can be coiled around the first spool 21 by rotating the first spool 21 to thereby fold the first shade 4. Furthermore, the second engagement portion 44 of the first shade 4 is mounted to the weight rod 31.

The structure of the second shade 5 is similar to the structure of the first shade 4. Specifically, the second shade 5 includes a plurality of second densely textured portions 51 and a plurality of second hollow portions 52 alternating with the second densely textured portions 51. Each second hollow portion 52 has a transmittance higher than a transmittance of each second densely textured portion 51. Each second densely textured portion 51 has a third width d3. Each second hollow portion 52 has a fourth width d4. The direction of the third width d3 and the fourth width d4 is the same as the direction from the second spool 22 towards the weight unit 3. The second shade 5 further includes third and fourth engagement portions 53 and 54 on two opposite ends thereof. The third engagement portion 53 of the second shade 5 is mounted to the second spool 22. The fourth engagement portion 54 of the second shade 5 is mounted to the positioning member 32. The fourth engagement portion 54 of the second shade 4 is received in the compartment 311, and the positioning member 32 is connected to the second shade 5 via the opening 313.

With reference to FIG. 3, by the above arrangement, the first shade 4 and the second shade 5 overlap with each other, such that the light can pass through the first shade 4 and the second shade 5 in sequence (or pass through the second shade 5 and the first shade 4 in sequence). The first width d1 and the second width d2 of the first shade 4 and the third width d3 and the fourth width d4 of the second shade 5 can be designed and adjusted according to the amount of light to be guided into the indoor space through the zebra shade as desired by the user. The present invention is not limited to this. In this embodiment, the first densely textured portions 41, the first hollow portions 42, the second densely textured portions 51, and the second hollow portions 52 of the zebra shade have an identical width, such that the light shielding efficiency of the zebra shade can be adjusted by the precise positional relationship between the first densely textured portions 41 and the first hollow portions 42 of the first shade 4 and the second densely textured portions 51 and the second hollow portions 52 of the second shade 5 (such as aligning or misaligning with each other).

Still referring to FIG. 3 showing the cross sectional view of the zebra shade of the first embodiment according to the present invention, when the user adjusts the position of the weight unit 3 by operating the transmission and coiling unit 6, since the first shade 4 and the second shade 5 engage with the spool unit 2 by the first engagement portion 43 and the third engagement portion 53, since the first shade 4 and the second shade 5 engage with the weight rod 31 and the positioning member 32 respectively by the second engagement portion 44 and the forth engagement portion 54, since first spool 21 and the second spool 22 are fixed to the supporting member 1, and since the weight rod 31 engages with the positioning member 32, when the spacing between the supporting member 1 and the weight rod 3 is changed (hereinafter referred to as “height adjustment step”) to fold or unfold the zebra shade, the first shade 4 and the second shade 5 are coiled or released by the same length upon rotation of the first spool 21 and the second spool 22, such that the relative positional relationships between the first densely textured portions 41 and the first hollow portions 42 of the first shade 4 relative to the second densely textured portions 51 and the second hollow portions 52 remain unchanged. Thus, the first shade 4 and the second shade 5 move synchronously without any relative movement therebetween, such that the first shade 4 and the second shade 5 remain the original positional relationship during the height adjustment step.

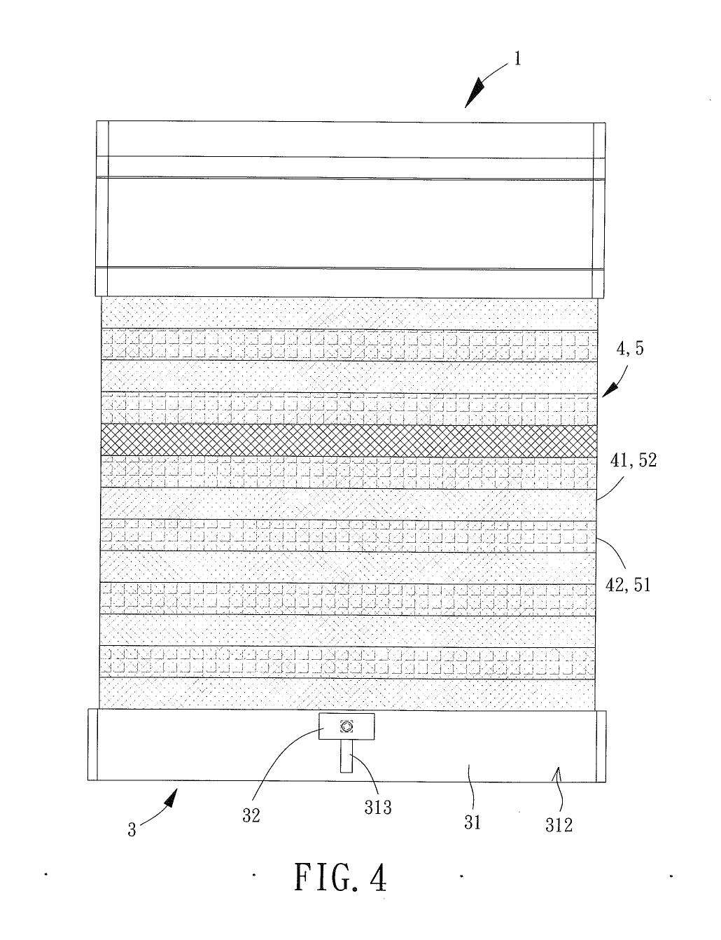

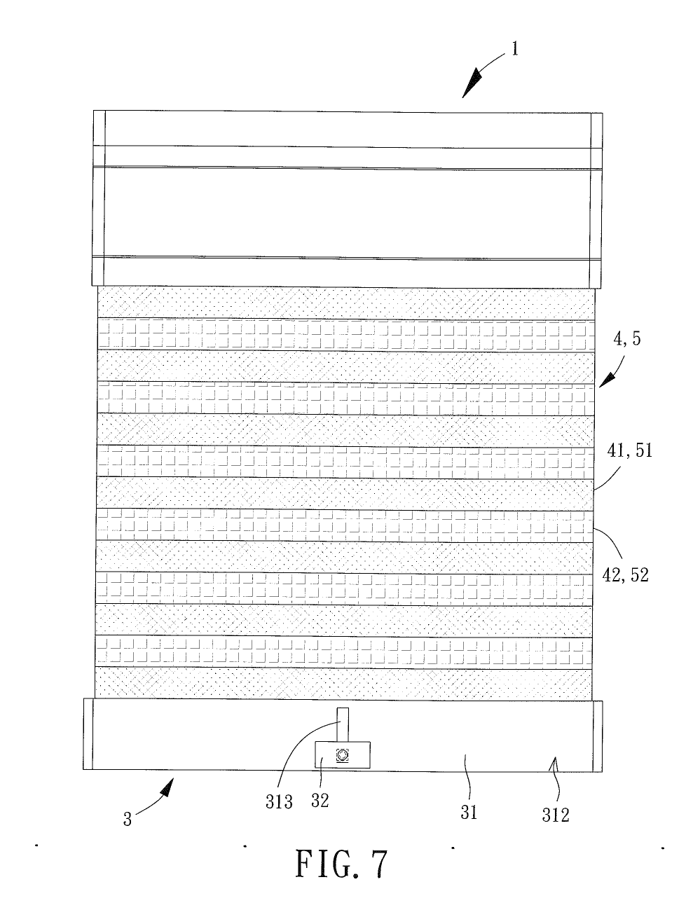

Specifically, the positional relationships between the first shade 4 and the second shade 5 can have many types. Two types of the positional relationships (namely the first type and the second type) will be described by way of example. With reference to FIG. 4, in the first type, the first densely textured portions 41 are aligned with the second hollow portions 52, and the first hollow portions 42 are aligned with the second densely textured portions 51. Due to the alignment between the first densely textured portions 41 and the second hollow portions 52 and the alignment between the first hollow portions 42 and the second densely textured portions 51, a large portion of the light is prevented from entering the indoor space. In the second type, the first densely textured portions 41 are aligned with the second densely textured portions 51, and the first hollow portions 42 are aligned with the second hollow portions 52, such that the amount of light entering the indoor space through the zebra shade is increased (see FIG. 7).

For ease of explanation, it is assumed that the zebra shade is in an initial state (i.e., the zebra shade is at an initial height), and the zebra shade can be positioned at the predetermined height by the height adjustment step. After the height adjustment step, relative movement between the first shade 4 and the second shade 5 will not occur, as mentioned above. Specifically, taking the zebra shade of the first embodiment according to the present invention as an example, if the alignment relationship between the first shade 4 and the second shade 5 in the initial state is of the first type, the zebra shade at the predetermined height still remains the first type after the height adjustment step.

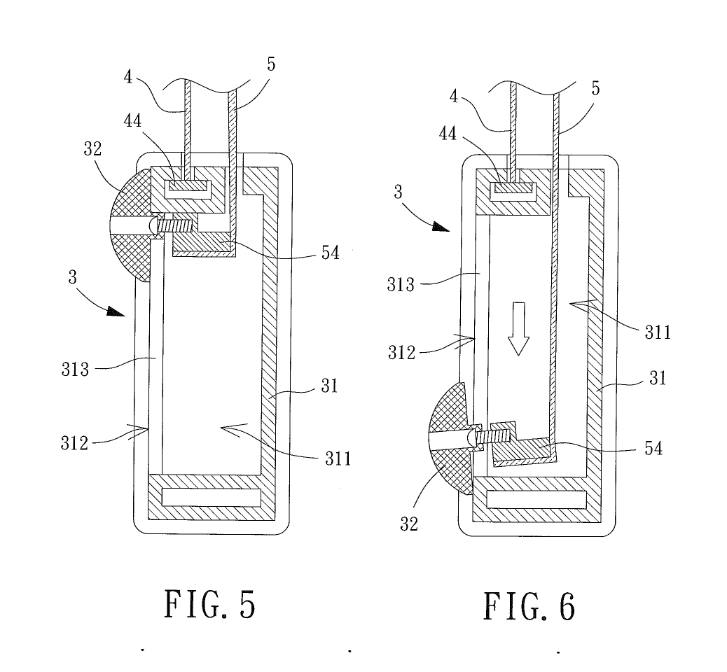

With reference to FIGS. 5-7, since the positioning member 32 is movably mounted on the weight rod 31 and since the positioning member 32 is mounted to the fourth engagement 54 of the second shade 54, after the user has adjusted the zebra shade to the predetermined height through the height adjustment step, the user can move the positioning member 32 relative to the weight rod 31 (see FIG. 6), such that the second shade 5 engaged with the positioning member 32 can be moved while the first shade 4 is positioned, thereby changing the positional relationship between the first shade 4 and the second shade 5 (namely, from the first type to the second type), such that the first densely textured portions 41 of the first shade 4 are aligned with the second densely textured portions 51 of the second shade 5 and such that the first hollow portions 42 of the first shade 4 are aligned with the second hollow portions 52 of the second shade 5, increasing the light input through the zebra shade, as shown in FIG. 7 showing the front view of the zebra shade of the first embodiment according to the present invention after the positioning member 32 has been moved to the position shown in FIG. 6.

Since the positional relationship between the first shade 4 and the second shade 5 remains unchanged during the height adjustment step, since the first shade 4 is connected to the weight rod 31, and since the second shade 5 is connected to the positioning member 32, after the user has adjusted the zebra shade to the predetermined height to shield a desired area of the window, the user can move the positioning member 32 relative to the weight rod 31 to change the positional relationship between the first shade 4 and the second shade 5 while maintaining the predetermined height, achieving precise adjustment of the light input.

With reference to FIG. 6, when the user applies a force to move the positioning member 32, the fourth engagement portion 54 of the second shade 5 will be subject to a coiling force from the transmission and coiling unit 6 to resist displacement of the positioning member 32. However, the coiling force can be counterbalanced by the active force between the positioning member 32 and the weight rod 31. For example, a face of the positioning member 32 in this embodiment presses against the engagement face 312. The face of the positioning member 32 has a high friction coefficient to counterbalance the coiling force by the frictional force between the positioning member 32 and the engagement face 312 of the weight rod 31, thereby positioning the positioning member 32 in a predetermined position. In another example, the face of the positioning member 32 and the engagement face 312 can be made of magnetic material to permit the positioning member 32 to be positioned by the magnetic attraction between the positioning member 32 and the weight rod 31. In a further example, a plurality of limiting portions is provided along a periphery of the opening 313, such as processing the opening 313 to include a serrated periphery (not shown), such that the positioning member 32 can move the second shade 5 to the predetermined position by stepped movement. Examples of changing the position of the positioning member 32 by application of a force while maintaining the predetermined position are set forth. However, other positioning provisions can be used.

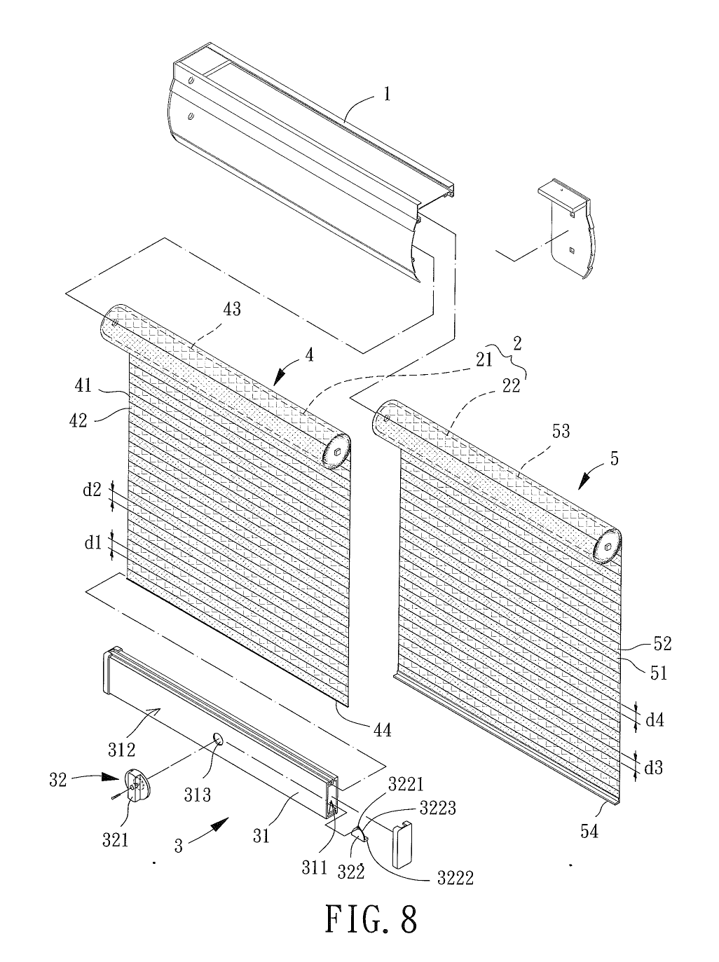

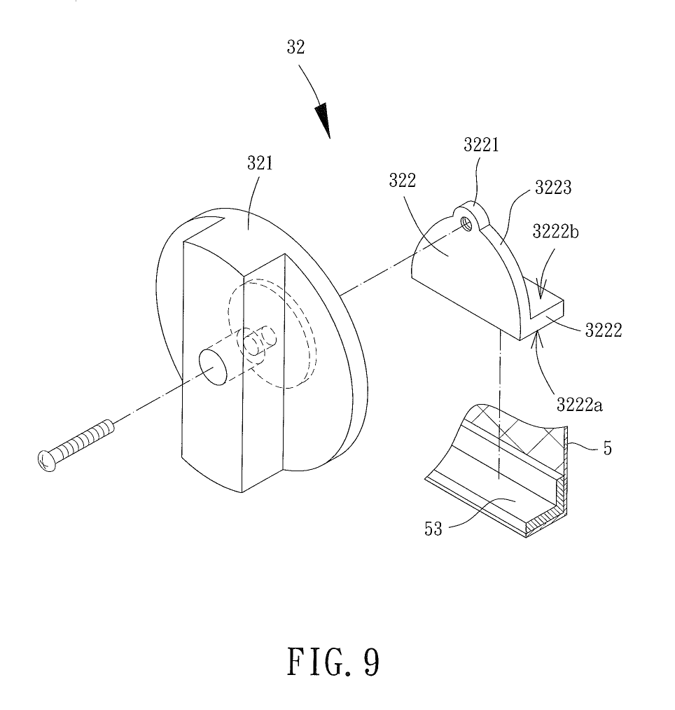

FIGS. 8 and 9 show a zebra shade of a second embodiment according to the present invention. In this embodiment, the components and the connections between the components are similar to those of the first embodiment, except that the positioning member 32 of the second embodiment includes a knob 321 and a pressing member 322. The knob 321 is located outside of the compartment 311, and the pressing member 322 is received in the compartment 311. Furthermore, the pressing member 322 includes a pressing portion 3222 and an axle portion 3221 respectively on two opposite sides of the pressing member 322. The axle portion 3221 of the pressing member 322 engages with the knob 321, such that when the user turns the knob 321, the pressing portion 3222 pivots about a pivot axis defined by the axle portion 3221. The pressing portion 3222 presses against and engages with the fourth engagement portion 54 of the second shade 5.

The pressing portion 3222 includes a first face 3222a and a second face 3222b opposite to the first face 3222a. Furthermore, the pressing member 322 includes an arcuate portion 3223 between the axle portion 3221 and the pressing portion 3222. By providing the arcuate portion 3223, the user can apply a smaller force to turn the knob 321 for actuating the pressing member 322. Furthermore, the pressing member 322 can be in the form of a cam or an eccentric wheel and should not be limited to the structure shown in FIG. 9.

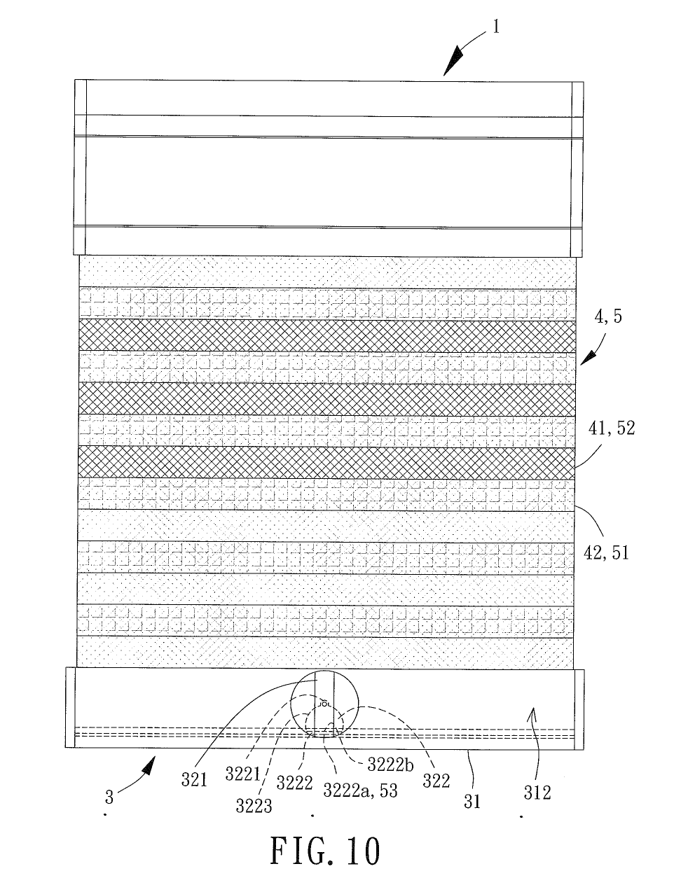

With reference to FIG. 10, the zebra shade of the second embodiment is identical to the zebra shade of the first embodiment in that the first and second shades 4 and 5 are respectively connected to the weight rod 31 and the positioning member 32 and in that the other ends of the first and second shades 4 and 5 are respectively mounted to the first and second spools 21 and 22, such that the positional relationship between the first shade 4 and the second shade 5 of the second embodiment remains unchanged before and after the height adjustment step. In this embodiment, the first shade 4 and the second shade 5 at the initial height and the predetermined height are in the positional relationship of the first type, such that the zebra shade can shield a large portion of the light from entering the indoor space.

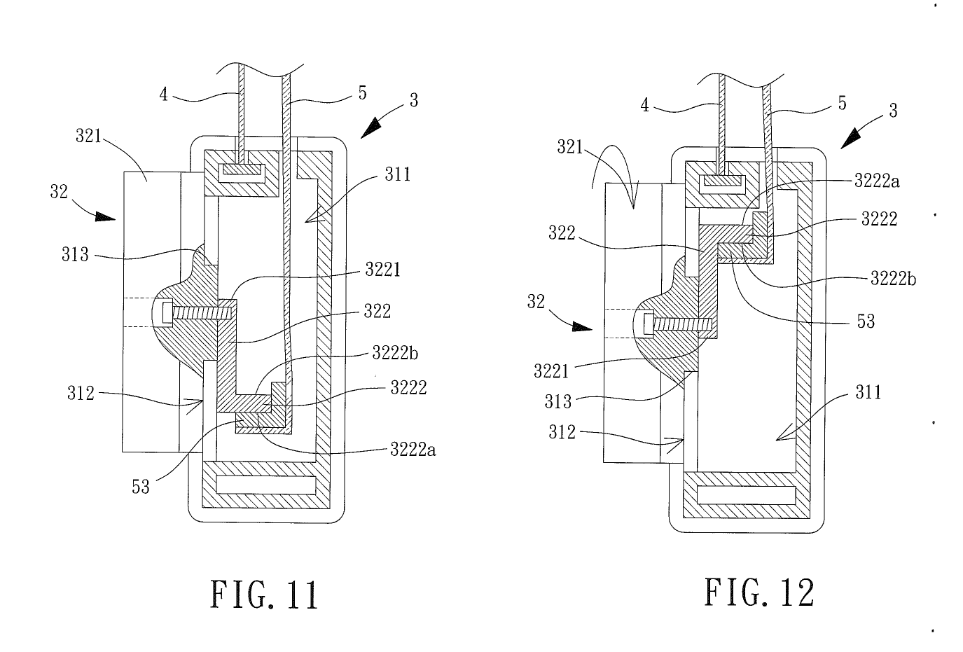

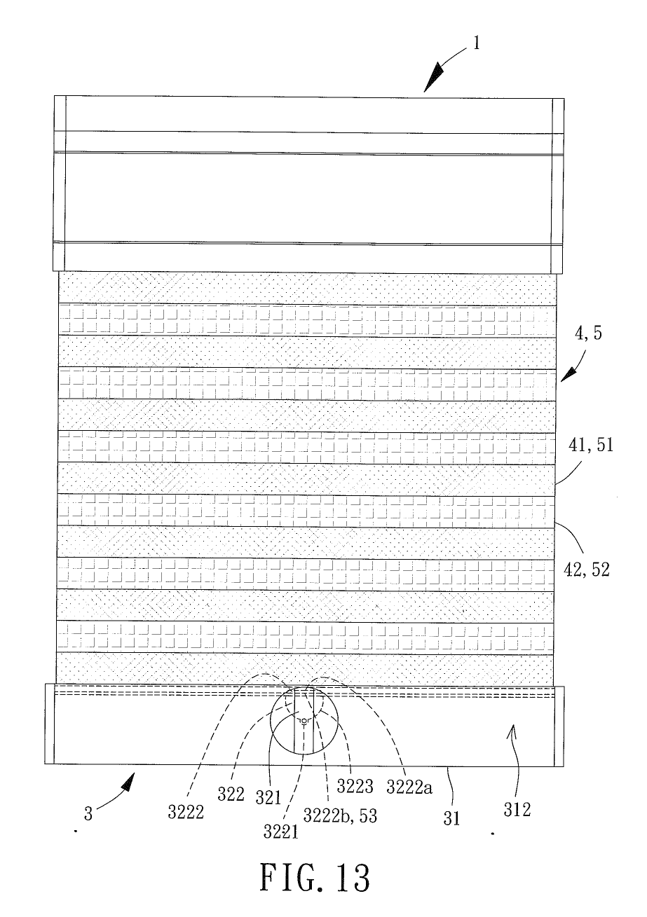

With reference to FIGS. 11 and 12, the pressing portion 3222 of the positioning member 32 engages with the fourth engagement portion 54 of the second shade 5. When the zebra shade is at the predetermined height, the positioning member 32 presses against the fourth engagement portion 54 of the second shade 5 by the first face 3222a. When the user intends to change the amount of light entering indoors through the zebra shade, the knob 321 is turned to pivot the pressing portion 3222 about the pivot axis defined by the axle portion 3221. During the pivotal movement, the pressing portion 3222 actuates the second shade 5 to move. After the knob 321 has been turned through a fixed angle, the pressing portion 3222 presses against the fourth engagement portion 54 by the second face 3222b to adjust the positional relationship between the first shade 4 and the second shade 5 while maintaining the zebra shade at the predetermined height. Namely, the positional relationship between the first shade 4 and the second shade 5 is changed from the first type to the second type in which the first hollow portions 42 are aligned with the second hollow portions 52 to increase the amount of light entering the indoor space through the zebra shade, as shown in FIG. 13 showing the front view of the zebra shade of the second embodiment according to the present invention after the positioning member 32 has been moved to a position shown in FIG. 12.

Furthermore, during the pivotal movement of the knob 321, although the transmission and coiling unit 6 also generates a coiling force to resist pivotal movement of the pressing portion 3222, the fourth engagement portion 54 is held by the pressing portion 3222 to counterbalance the coiling force while positioning the fourth engagement portion 54 in the predetermined position after the pivotal movement. Furthermore, provision of the arcuate portion 3223 permits the user to easily turn the knob 321 for actuating the fourth engagement portion 54 through transmission by the pressing portion 322, changing the positional relationship between the first shade 4 and the second shade 5.

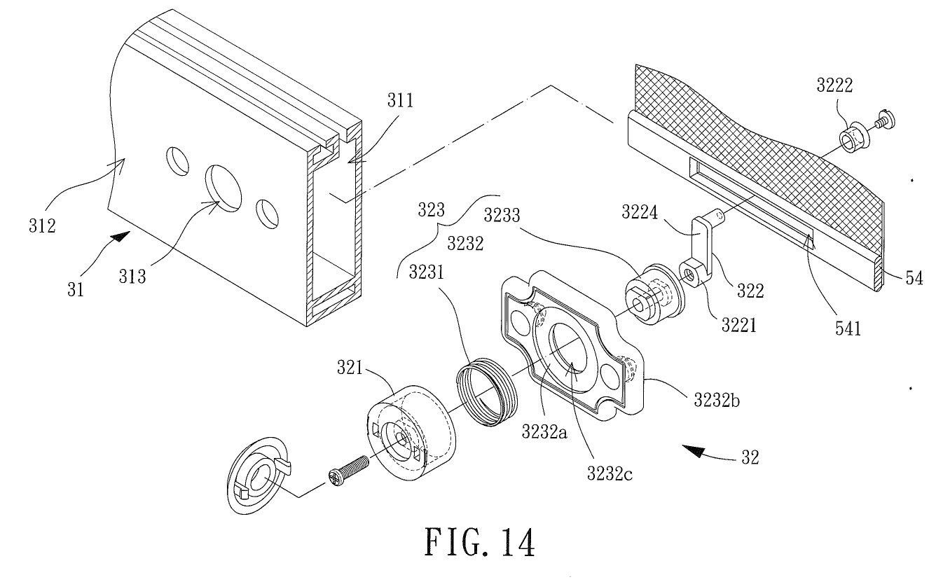

FIG. 14 shows is a zebra shade of a third embodiment according to the present invention. In this embodiment, the components and the connection relationships between the components of the zebra shade are similar to those of the second embodiment, except that the positioning member 32 of the third embodiment further includes a limiting unit 323, and the fourth engagement portion 54 includes a slot 54. The pressing portion 3222 of the pressing member 322 is movably received in the slot 541. Furthermore, the pressing member 322 includes a lever 3224 between the axle portion 3221 and the pressing portion 3222. The length of the lever 3224 decides the displacement of the second shade 5 actuated by the pivoted pressing portion 3222. The limiting unit 323 is mounted between the knob 321 and the pressing member 322. The limiting unit 323 is used to position the pressing portion 3222 of the pressing member 322 in an appropriate location to avoid the fourth engagement portion 54 from being returned under the coiling force after the second shade 5 has been moved by turning the knob 321. Furthermore, the slot 541 can extend through two opposite faces of the fourth engagement portion 54. In another example, the slot 541 can be a recess in a face of the fourth engagement portion 54. The present invention is not limited in this regard. In this embodiment, the slot 541 extends through the fourth engagement portion 54, and an end of the pressing portion 3222 is larger than the size of the fourth engagement portion 54, such that when the pressing member 322 is inserted through the slot 541 from one of the faces of the fourth engagement portion 54, the pressing portion 3222 engages with the pressing member 322 at the other face of the fourth engagement portion 54 to securely retain the pressing member 322 in the slot 541.

Specifically, in this embodiment, the limiting unit 323 includes a spring 3231, a decorative plate 3232, and a connection seat 3233. The decorative plate 3232 includes a front face 3232a and a rear face 3232b opposite to the front face 3232a. The decorative plate 3232 further includes a through-hole 3232c extending from the front face 3232a through the rear face 3232b. The connection seat 3233 extends through the through-hole 3232c. The spring 3231 is mounted around the connection seat 3233. The connection seat 3233 includes two opposite ends respectively engaged with the knob 321 and the axle portion 3221 of the pressing member 322, such that the spring 3231 is located between the knob 321 and the front face 3232a of the decorative plate 3232. However, the positioning member 32 can have other arrangements.

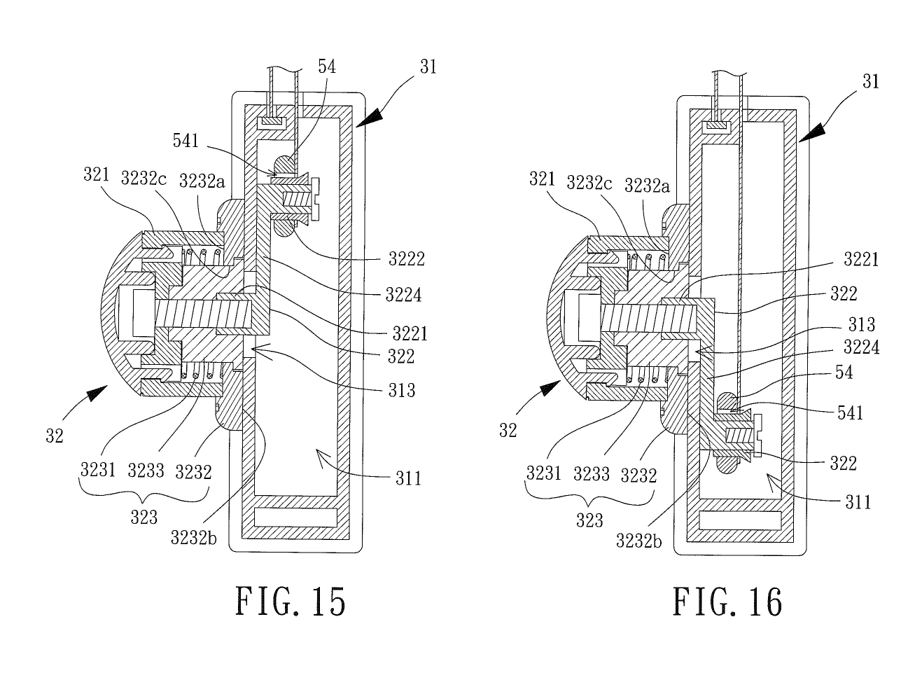

With reference to FIGS. 15 and 16, the pressing portion 3222 of the pressing member 322 is movably mounted on the fourth engagement portion 54, and the pressing portion 3222 and the lever 3224 are received in the compartment 311 of the weight rod 31. The axle portion 3221 of the pressing member 322 extends outside of the compartment 311 via the opening 313. The axle portion 3221 engages with the limiting unit 323 and the knob 321. The rear face 3232b of the decorative cover 3232 presses against the engagement face 312 of the weight rod 31. When the user intends to change the amount of light entering indoors through the zebra shade, the knob 321 is pivoted. Since the knob 321 engages with the axle portion 3221 of the pressing member 322 and since the pressing portion 3222 is movably received in the slot 541, the pressing portion 3222 pivots about a pivot axis defined by the axle portion 3221 through transmission by the lever 3224 to move the second shade 5, changing the positional relationship between the first shade 4 and the second shade 5. Furthermore, during the pivotal movement of the knob 321, although the transmission and coiling unit 6 also generates a coiling force which tends to return the pressing member 322, since two opposite ends of the spring 3231 of the limiting unit 323 respectively abut the knob 321 and the front face 3232a of the decorative plate 3231 to providing a limiting effect on the knob 321, the coiling force is counterbalanced to prevent the pressing member 322 engaged with the knob 321 from pivoting, positioning the second shade 5 in the predetermined position.

In view of the foregoing, the zebra shade according to the present invention includes the first shade 4 and the second shade 5 which are mounted to the spool unit 2 by the first engagement portion 43 and the third engagement portion 53, respectively and which are connected to the weight rod 31 and the positioning member 32 by the second engagement portion 44 and the fourth engagement portion 54, respectively. The positioning member 32 is movably mounted on the weight rod 31 to permit the user to move the positioning member 32 for changing the positional relationship between the first shade 4 and the second shade 5 while the zebra shade is at the predetermined height. The amount of light entering indoors through the zebra shade can be adjusted to increase the light shielding accuracy of the zebra shade.

In the above example in which the first width d1, the second width d2, the third width d3, and the fourth width d4 are identical to each other, the amount of light to be guided into the indoor space through the zebra shade is adjusted by changing the positional relationship between the first shade 4 and the second shade 5. However, some of the above widths can be the same or different according to the needs in the brightness of the indoor space and the desired visual effects. Furthermore, in the above example, the first densely textured portions 41 completely align or misalign with the second densely textured portions 51 or the second hollow portions 52. However, the user can make the first densely textured portions 41 to partially align or partially misalign with the second densely textured portions 51 or the second hollow portions 52 according to the amount of light to be guided into the indoor space. Thus, the present invention should not be limited to the first and second embodiments.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A zebra shade comprising:
a supporting member;
a spool unit rotatably mounted to the supporting member, with the spool unit including a first spool and a second spool;
a weight unit including a weight rod and a positioning member, with the positioning member movably mounted on the weight rod;
a first shade including a plurality of first densely textured portions and a plurality of first hollow portions alternating with the plurality of densely textured portions, with the first shade further including first and second engagement portions on two opposite ends thereof, with the first engagement portion of the first shade mounted to the first spool, and with the second engagement portion of the first shade mounted to the weight rod; and
a second shade including a plurality of second densely textured portions and a plurality of second hollow portions alternating with the plurality of second densely textured portions, with the second shade further including third and fourth engagement portions on two opposite ends thereof, with the third engagement portion of the second shade mounted to the second spool, and with the fourth engagement portion of the second shade mounted to the positioning member.

2. The zebra shade as claimed in claim 1, wherein the plurality of first densely textured portions, the plurality of first hollow portions, the plurality of second densely textured portions, and the plurality of second hollow portions have an identical width.

3. The zebra shade as claimed in claim 2, wherein the plurality of first densely textured portions is aligned with the plurality of second hollow portions, and the plurality of first hollow portions is aligned with the plurality of second densely textured portions.

4. The zebra shade as claimed in claim 2, wherein the plurality of first densely textured portions is aligned with the plurality of second densely textured portions, and the plurality of first hollow portions is aligned with the plurality of second hollow portions.

5. The zebra shade as claimed in claim 1, with the weight rod including a compartment and an opening in communication with the compartment, with the fourth engagement portion of the second shade received in the compartment, and with the positioning member extending through the opening to engage with the fourth engagement portion.

6. The zebra shade as claimed in claim 5, with the positioning member including a knob and a pressing member engaged with the knob, with the knob located outside of the compartment, with the pressing member received in the compartment, with the pressing member including a pressing portion, and with the pressing portion of the positioning member pressing against and engaged with the fourth engagement portion of the second shade.

7. The zebra shade as claimed in claim 6, with the pressing member including the pressing portion and an axle portion respectively on two opposite sides of the pressing member, with the axle portion of the pressing member engaged with the knob, and with the pressing portion pressing against and engaged with the fourth engagement portion.

8. The zebra shade as claimed in claim 7, wherein the pressing member includes an arcuate portion between the axle portion and the pressing portion.

9. The zebra shade as claimed in claim 5, with the positioning member including a knob and a pressing member engaged with the knob, with the knob located outside of the compartment, with the pressing member received in the compartment, with the pressing member including the pressing portion and an axle portion respectively on two opposite sides of the pressing member, with the fourth engagement portion including a slot, and with the pressing portion movably received in the slot.

10. The zebra shade as claimed in claim 9, with the positioning member further including a limiting unit between the knob and the pressing member.

11. The zebra shade as claimed in claim 9, with the limiting unit including a spring, a decorative plate, and a connection seat, with the decorative plate including a front face and a rear face, with the decorative plate further including a through-hole extending from the front face through the rear face, with the connection seat extending through the through-hole, with the spring mounted around the connection seat, and with the connection seat including two opposite ends respectively engaged with the knob and the axle portion of the pressing member, such that two opposite ends of the spring respectively abut the knob and the front face of the decorative plate.
